(19) United States
(12) Patent Application Publication
(10) Pub. No.: US 2019/0308044 A1
(43) Pub. Date: Oct. 10, 2019

(54) POTASSIUM SALT FIRE SUPPRESSION SOLUTION WITH VERMICULITE

(71) Applicant: Kidde Graviner Limited, Solihull (GB)

(72) Inventors: Adam Chattaway, Berkshire (GB); Harlan Hagge, Knightdale, NC (US)

(21) Appl. No.: 15/948,511

(22) Filed: Apr. 9, 2018

(51) Int. Cl. A62C 5/00

(52) U.S. Cl. CPC A62C 5/008

(57) ABSTRACT

A fire suppression agent includes a potassium salt solution and vermiculite particles stored in isolation from the potassium salt solution. The vermiculite particles remain isolated from the potassium salt solution until triggered to mix with the potassium salt solution upon a discharge event.

### BACKGROUND

Aqueous potassium salt solutions are effective for extinguishing class B (combustible liquids/gases) fires, and to some extent, class A (combustible nonmetal solids) fires. These solutions are not, however, effective in extinguishing lithium battery fires. Aqueous solutions of vermiculite, a naturally-occurring flaky mineral, have been shown to be effective for extinguishing lithium battery fires.

Commercial vehicles (e.g., buses, coaches, aircraft, etc.) can be at risk for multiple classes of fire, especially given the recent prevalence of lithium battery fires caused by personal electronic devices. Transportation regulations may require fire extinguishers and/or fixed fire systems throughout a vehicle, and they often contain different fire suppression agents based on the most likely type or types of fire in that space. A single fire suppression agent suitable for use with multiple classes of fire may be more effective and economical.

### SUMMARY

A fire suppression agent includes a potassium salt solution and vermiculite particles stored in isolation from the potassium salt solution. The vermiculite particles remain isolated from the potassium salt solution until triggered to mix with the potassium salt solution upon a discharge event.

A fire suppression system includes a fire suppression agent comprising a potassium salt solution and vermiculite particles. The system further includes a first container for storing the potassium salt solution and a second container for storing the vermiculite particles. The vermiculite particles remain isolated from the potassium salt solution until triggered to mix with the potassium salt solution upon a discharge event.

A method of forming a fire suppression system suitable for suppressing a fire comprising a lithium battery includes placing a potassium salt solution in a first container and placing vermiculite particles in a second container. The vermiculite particles remain isolated from the potassium salt solution until triggered to mix with the potassium salt solution upon a discharge event.

### BRIEF DESCRIPTION OF THE DRAWINGS

FIG. 1 is a simplified illustration of an embodiment of a fire suppression system employing a vermiculite-based fire suppression agent.

FIG. 2 is a simplified illustration of an alternative embodiment of a fire suppression system employing the vermiculite-based fire suppression agent.

### DETAILED DESCRIPTION

The present invention is directed to a hybrid fire suppression agent and a system employing the fire suppression agent. The fire suppression agent is a mixture of a concentrated potassium salt solution and vermiculite particles. Vermiculite can be effective in extinguishing class A fires and lithium battery fires, which can include both rechargeable lithium ion batteries and non-rechargeable lithium (i.e., lithium metal) batteries. With the existing fire suppression capabilities of the potassium salt solution, the hybrid agent can be used to fight multiple classes of fires.

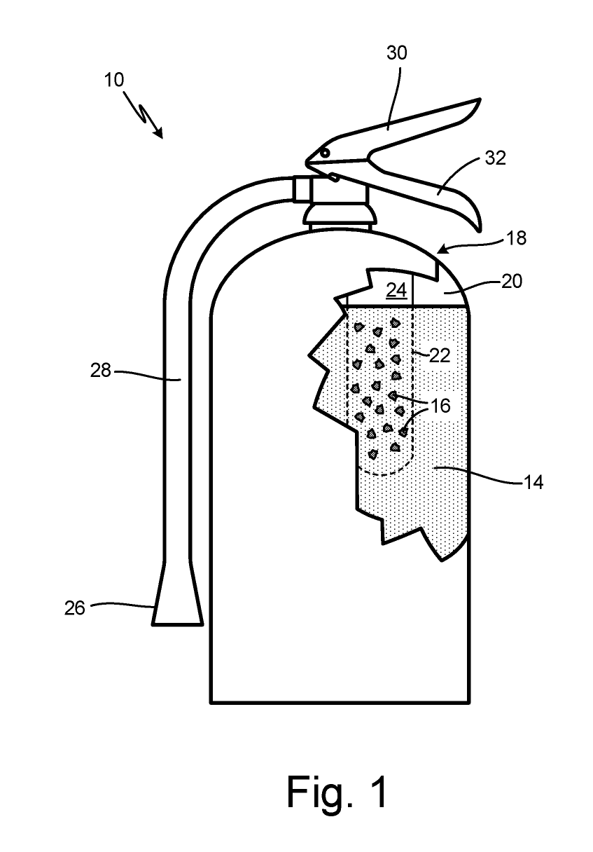

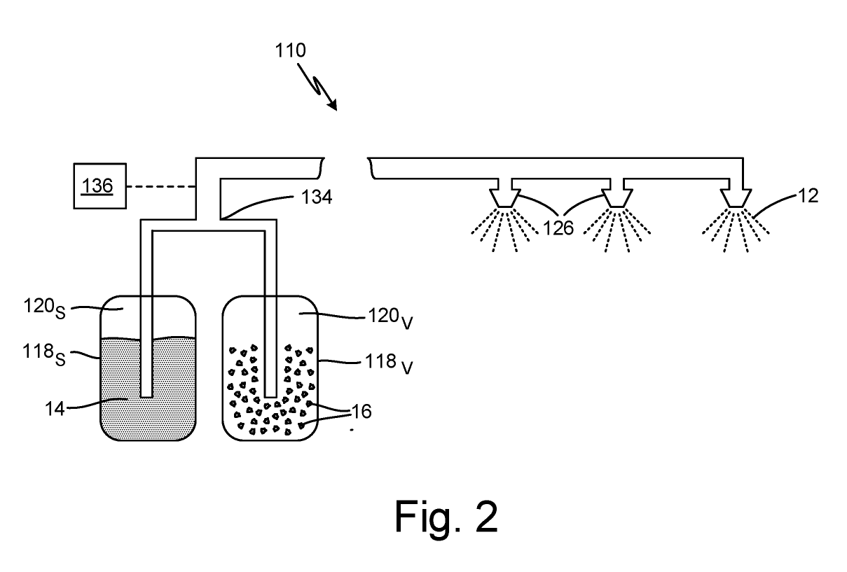

FIG. 1 is a simplified illustration of fire suppression system 10, configured to discharge fire suppression agent 12 (shown in FIG. 2). Fire suppression agent 12 includes potassium salt solution 14 and vermiculite particles 16, which, as can be seen in FIG. 1, are stored separately within the multi-container system 10. In the embodiment shown, system 10 include a first container as vessel 18, which is a pressure vessel and is configured as a portable (e.g., handheld) extinguisher. Vessel 18 includes inner volume 20 which can be partially or fully occupied by salt solution 14. A second container, container 22, is disposed within vessel 18, occupying a portion of inner volume 20. Container 22 includes inner volume 24 which can be partially or fully occupied by vermiculite particles 16.

Vessel 18 further includes nozzle 26 connected to hose 28, handle 30, and lever 32. Container 22 is configured to keep vermiculite particles 16 separated from salt solution 14 until system 10 is triggered to discharge, upon which time the two substances can interact just before or during discharge. In the embodiment shown, fire suppression agent 12 can be discharged through hose 28 and nozzle 26 via actuation of lever 32. Container 22 can be configured as frangible container designed to rupture and spill its contents (i.e., vermiculite particles 16) into inner volume 20 and salt solution 14. This can be accomplished, for example, by mechanically puncturing container 22 (e.g., using a pin), or by increasing the pressure within inner volume 20 (e.g., by activating an internal CO₂ cartridge) to rupture container 22. Container 22 can alternatively remain intact during operation of system 10, and can be fluidly connected via a tube or other fluid line, to inner volume 20 and/or nozzle 26. In alternative embodiments, nozzle 26 can be configured without hose 28, and can further include any tap, valve, or port suitable for placing inner volume 20 and/or inner volume 24 in fluid communication with the environment. Alternative embodiments can further include the placement of container 22 within, for example, nozzle 26 or hose 28.

Vermiculite particles 16 can range from about 1 micron to 300 microns in diameter. In an exemplary embodiment, the Dv90 diameter (the diameter of particles occupying 90% of the total volume) is less than 200 microns, while the Dv50 diameter (median diameter) is less than 85 microns. Further, the concentration of vermiculite particles 16 within fire suppression agent 12 ranges from about 5% to 40% by weight, and in an exemplary embodiment, from about 13% to 20% by weight. Other particle diameter distributions and concentrations are possible, and can vary based on, for example, specific fire suppression needs, system parameters, and to prevent settling of vermiculite particles 16. Potassium salt solution 14 can be an aqueous solution containing one or more salts of potassium acetate, potassium lactate, and potassium citrate. The concentration of the potassium salt in solution 14 can be as high as 60% by weight. Other salts and combinations of salts are contemplated herein, and may be selected based on fire suppression needs and vermiculite compatibility.

FIG. 2 is a simplified schematic illustration of alternative fire suppression 110. System 110 can be a fixed fire suppression system (e.g., in an aircraft cargo hold or a unit load device) configured to discharge fire suppression agent 12 into an enclosed space via one or more nozzles 126. System 110 includes a plurality of independent containers/vessels 118—a first vessel 118_{S} for storing salt solution 14, and a second vessel 118_{V} for storing vermiculite particles 16. Vessel 118_{S} includes inner volume 120_{S} that can be fully or partially occupied by salt solution 14, and vessel 118_{V} includes inner volume 120_{V} that can be fully or partially occupied by vermiculite particles 16. Vessels 118 are fluidly connected to mixing junction 134, and in some embodiments, each vessel 118 is individually pressurized such that individual vessel contents (i.e., salt solution 14 and vermiculite particles 16) output at a flow rate selected to provide a desired proportion of mixing at junction 134. In other embodiments, one vessel 118 can be pressurized, and the flowing of its contents can act to entrain/educe the contents of the other vessel(s). Further, while vessels 118 are shown in FIG. 2 as right-side up, vessels 118 can alternatively be inverted.

Fire suppression system 110 can further include one or more sensors 136 for detecting a fire and/or automatically discharging fire suppression agent 12. Exemplary sensors can include one or a combination of smoke detectors, thermal sensors, ultraviolet sensors, and infrared sensors.

Those of skill in the art will appreciate that is further possible to design a portable fire suppression system 10 having a plurality of individual vessels 18. Such a system might be worn by an operator as a back or shoulder pack, or could be mounted on a cart or other mobile platform. It is further possible to design a fixed system 110 having a single large vessel 118, and a smaller vermiculite container 122 disposed within the vessel, similar to the embodiment shown in FIG. 1 with respect to system 10. Any of the disclosed embodiments can further include gas generators, or be super-pressurized with nitrogen or other gases or mixtures to facilitate discharge of fire suppression agent 12.

The disclosed fire suppression agent and systems have many benefits. The vermiculite is effective against lithium battery and class A fires, while the potassium salt agent is effective against class B fires. Besides commercial vehicles, the disclosed fire suppression agent and system can be used in other transportation industries (e.g., railroad, maritime, etc.), factories, laboratories, private residences, and more.

Discussion of Possible Embodiments

The following are non-exclusive descriptions of possible embodiments of the present invention.

A fire suppression agent includes a potassium salt solution and vermiculite particles stored in isolation from the potassium salt solution. The vermiculite particles remain isolated from the potassium salt solution until triggered to mix with the potassium salt solution upon a discharge event.

The fire suppression agent of the preceding paragraph can optionally include, additionally and/or alternatively, any one or more of the following features, configurations and/or additional components:

In the above fire suppression agent, a concentration of the vermiculite particles can range from 5% to 40% by weight.

In any of the above fire suppression agents, a Dv90 diameter of the vermiculite particles can be less than 200 μm.

In any of the above fire suppression agents, a Dv50 diameter of the vermiculite particles can be less than 85 μm.

In any of the above fire suppression agents, the potassium salt solution can include a salt selected from the group consisting of potassium acetate, potassium citrate, potassium lactate, and combinations thereof.

Any of the above fire suppression agents can be capable of suppressing a fire comprising at least one of a combustible nonmetal solid, a combustible fluid, and a lithium battery.

A fire suppression system includes a fire suppression agent comprising a potassium salt solution and vermiculite particles. The system further includes a first container for storing the potassium salt solution and a second container for storing the vermiculite particles. The vermiculite particles remain isolated from the potassium salt solution until triggered to mix with the potassium salt solution upon a discharge event.

The fire suppression system of the preceding paragraph can optionally include, additionally and/or alternatively, any one or more of the following features, configurations and/or additional components:

The above fire suppression system can be capable of suppressing a fire comprising at least one of a combustible nonmetal solid, a combustible fluid, and a lithium battery.

In any of the above fire suppression systems, the first or second container can be a pressure vessel.

In any of the above fire suppression systems, the second container can be disposed within the pressure vessel.

In any of the above fire suppression systems, the second container can be a frangible container.

In any of the above fire suppression systems, the first container can be portable.

In any of the above fire suppression systems, the potassium salt solution can include a salt selected from the group consisting of potassium acetate, potassium citrate, potassium lactate, and combinations thereof.

A method of forming a fire suppression system suitable for suppressing a fire comprising a lithium battery includes placing a potassium salt solution in a first container and placing vermiculite particles in a second container. The vermiculite particles remain isolated from the potassium salt solution until triggered to mix with the potassium salt solution upon a discharge event.

The method of the preceding paragraph can optionally include, additionally and/or alternatively, any one or more of the following features, configurations and/or additional components:

In the above method, the vermiculite particles can mix with the potassium salt solution within the first container.

In any of the above methods the vermiculite particles can mix with the potassium salt solution within a mixing junction external to the first and second containers.

In any of the above methods, a concentration of the vermiculite particles can range from 5% to 40% by weight.

In any of the above methods, the potassium salt solution can include a salt selected from the group consisting of potassium acetate, potassium citrate, potassium lactate, and combinations thereof.

In any of the above methods, the fire suppression system can further be capable of suppressing a fire comprising at least one of a combustible nonmetal solid and a combustible fluid.

Any of the above methods can further include disposing the second container within the first container.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fire suppression agent comprising:
a potassium salt solution; and
vermiculite particles stored in isolation from the potassium salt solution;
wherein the vermiculite particles remain isolated from the potassium salt solution until triggered to mix with the potassium salt solution upon a discharge event.

2. The fire suppression agent of claim 1, wherein a concentration of the vermiculite particles ranges from 5% to 40% by weight.

3. The fire suppression agent of claim 1, wherein a Dv90 diameter of the vermiculite particles is less than 200 μm.

4. The fire suppression agent of claim 1, wherein a Dv50 diameter of the vermiculite particles is less than 85 μm.

5. The fire suppression agent of claim 1, wherein the potassium salt solution comprises a salt selected from the group consisting of potassium acetate, potassium citrate, potassium lactate, and combinations thereof.

6. The fire suppression agent of claim 1, wherein the fire suppression agent is capable of suppressing a fire comprising at least one of:
a combustible nonmetal solid;
a combustible fluid; and
a lithium battery.

7. A fire suppression system comprising:
a fire suppression agent comprising:
a potassium salt solution; and
vermiculite particles;
a first container for storing the potassium salt solution; and
a second container for storing the vermiculite particles;
wherein the vermiculite particles remain isolated from the potassium salt solution until triggered to mix with the potassium salt solution upon a discharge event.

8. The system of claim 7, wherein the fire suppression agent is capable of suppressing a fire comprising at least one of:
a combustible nonmetal solid;
a combustible fluid; and
a lithium battery.

9. The system of claim 7 and further comprising: wherein the first or second container is a pressure vessel.

10. The system of claim 7, wherein the second container is disposed within the pressure vessel.

11. The system of claim 10, wherein the second container is a frangible container.

12. The system of claim 7, wherein the first container is portable.

13. The system of claim 7, wherein the potassium salt solution comprises a salt selected from the group consisting of potassium acetate, potassium citrate, potassium lactate, and combinations thereof.

14. A method of forming a fire suppression system suitable for suppressing a fire comprising a lithium battery, the method comprising:
placing a potassium salt solution in a first container; and
placing vermiculite particles in a second container;
wherein the vermiculite particles remain isolated from the potassium salt solution until triggered to mix with the potassium salt solution upon a discharge event.

15. The method of claim 14, wherein the vermiculite particles mix with the potassium salt solution within the first container.

16. The method of claim 14, wherein the vermiculite particles mix with the potassium salt solution within a mixing junction external to the first and second containers.

17. The method of claim 14, wherein a concentration of the vermiculite particles ranges from 5% to 40% by weight.

18. The method of claim 14, wherein the potassium salt solution comprises a salt selected from the group consisting of potassium acetate, potassium citrate, potassium lactate, and combinations thereof.

19. The method of claim 14, wherein the fire suppression system is further capable of suppressing a fire comprising at least one of:
a combustible nonmetal solid; and
a combustible fluid.

20. The method of claim 14 and further comprising: disposing the second container within the first container.
